(19) United States
(12) Patent Application Publication
(10) Pub. No.: US 2016/0065690 A1
(43) Pub. Date: Mar. 3, 2016

(54) SYSTEM AND METHOD FOR SELECTING VIRTUAL DESKTOP ENVIRONMENT

(71) Applicant: Kabushiki Kaisha Toshiba, Tokyo (JP)

(72) Inventors: Tomohiro Hanyu, Ome Tokyo (JP); Yoshihiro Kaneko, Fussa Tokyo (JP)

(21) Appl. No.: 14/675,948

(22) Filed: Apr. 1, 2015

(30) Foreign Application Priority Data
Aug. 27, 2014 (JP) 2014-172408

(51) Int. Cl. H04L 29/08; G06F 3/0488

(52) U.S. Cl. CPC H04L 67/303; G06F 3/0488; H04L 67/10

(57) ABSTRACT

According to one embodiment, an information processing apparatus detects a current configuration of the apparatus from a first configuration in which the body is attached to a device includes a keyboard and a second configuration in which the body is separated from the device and transmits state data indicative of the detected configuration to a server. The server selects a first virtual desktop environment, based on the state data, from a first virtual desktop environment capable of delivering a first virtual desktop image for the first configuration and a second virtual desktop environment capable of delivering a second virtual desktop image for the second configuration, and executes the virtual desktop environment using a first virtual machine.

### CROSS-REFERENCE TO RELATED APPLICATIONS

This application is based upon and claims the benefit of priority from Japanese Patent Application No. 2014-172408, filed Aug. 27, 2014, the entire contents of which are incorporated herein by reference.

### FIELD

Embodiments described herein relate generally to a technique for desktop virtualization.

### BACKGROUND

In recent years, many businesses are beginning to introduce desktop virtualization for the purposes of reducing management costs for client devices and the like.

In desktop virtualization, a server provides a virtual desktop environment (including operating system and application programs) to each client device. The virtual desktop environment is executed by the server. The client device displays on its display a virtual desktop image delivered from the server.

Aside from this trend, personal computers (PCs) that share the features of notebook personal computers and tablet devices have been developed in recent years. Such computer (PC) is referred to as a two-in-one PC. A two-in-one PC can be used not only as an ordinary notebook computer but also as a tablet device as required.

Thus, such two-in-one PCs will probably be used as client devices for desktop virtualization.

However, in general, the virtual desktop image types delivered from a server to client devices are fixed, and thus, the feature of a two-in-one PC usable not only as a notebook computer but also as a tablet device may be ineffective in desktop virtualization.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view which shows the exterior of an information processing apparatus of an embodiment in tablet style.

FIG. 2 is an exemplary perspective view which shows a relationship between a body of the information processing apparatus of the embodiment and a base (device) with a keyboard.

FIG. 3 is an exemplary perspective view which shows the exterior of the information processing apparatus of the embodiment in notebook style (PC style).

FIG. 4 is an exemplary view which shows virtual desktop images provided by a server for the information processing apparatus of the embodiment in PC style.

FIG. 5 is an exemplary view which shows virtual desktop images provided by a server for the information processing apparatus of the embodiment in tablet style.

FIG. 6 is an exemplary block diagram which shows the structure of the information processing apparatus of the embodiment and the structure of the server.

FIG. 7 is an exemplary view which shows a communication procedure executed between the information processing apparatus of the embodiment and the server.

FIG. 8 is an exemplary block diagram which shows a hardware structure of the information processing apparatus of the embodiment.

FIG. 9 is an exemplary flowchart which shows a process procedure executed by the information processing apparatus of the embodiment.

FIG. 10 is an exemplary flowchart which shows a process procedure executed by the server.

### DETAILED DESCRIPTION

Various embodiments will be described hereinafter with reference to the accompanying drawings.

In general, according to one embodiment, a system includes an information processing apparatus and a server. The information processing apparatus includes a body comprising a touch-screen display, and a first processor. The first processor executes a process to detect a current configuration of the information processing apparatus from a first configuration in which the body is attached to a device comprising a keyboard and a second configuration in which the body is separated from the device. The first processor executes a process to transmit state data indicative of the detected configuration to the server. The server includes a second processor. The second processor selects a virtual desktop environment, based on the state data, from a first virtual desktop environment capable of delivering a first virtual desktop image for the first configuration and a second virtual desktop environment capable of delivering a second virtual desktop image for the second configuration, and executes the virtual desktop environment using a first virtual machine.

With reference to FIGS. 1 to 3, the structure of information processing device of one embodiment is explained. The information processing device is realized as a computer (hereinafter referred to as a two-in-one PC) 10 which can be used as a notebook personal computer (PC) and also a tablet device.

The two-in-one PC 10 includes an attachment mechanism to enable the easy detachable attachment of a body 11 of the computer 10 to a base 22 with a keyboard 23. That is, the body 11 of the two-in-one PC 10 includes a connector 14 and is detachably attached to the base 22 via connector 14.

The base 22 is a device including the keyboard 23. The device including the keyboard 23 may be, for example, a detachable keyboard (keyboard base) which can be detachably attached to (combined with) the body 11.

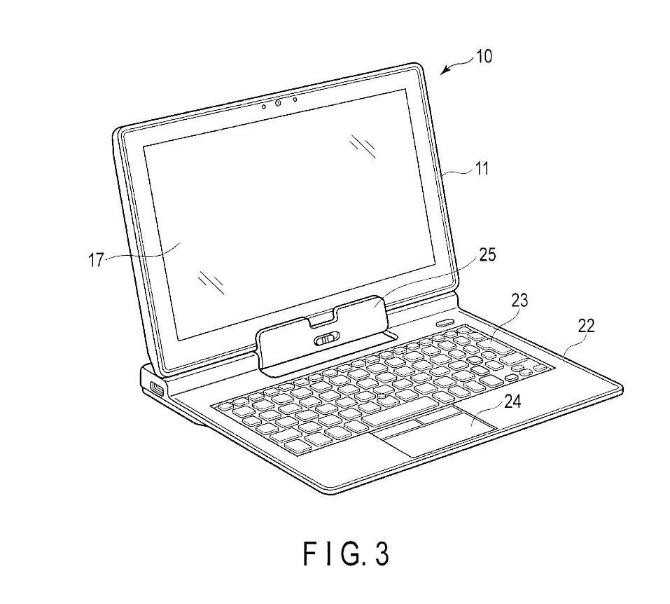

The PC 10 can be used as a personal computer (as PC style (notebook configuration) shown in FIG. 3). Furthermore, if there is no need to use a keyboard or a mouse, the PC 10 can be used as a tablet device (as tablet style (tablet configuration) in FIG. 1) by detaching the body 11 of the computer 10 from the base 22.

For example, a user uses the two-in-one PC 10 in notebook configuration at his/her desk in an office, and when attending a meeting in a conference room, he/she detaches the body 11 from the base 22 and brings the body 11 to the meeting as the computer 10 in tablet style.

FIG. 1 shows the exterior of the two-in-one PC 10 when it is in tablet style. The PC 10 includes, as shown in FIG. 1, the body 11 and a touch-screen display 17. The touch-screen display 17 is attached to the body 11 to match the front of the body 11.

The body 11 has a thin box-like casing. A power button 12, USB port 13, and the like are arranged at a side surface, for example, on the right of the body 11. The touch-screen display 17 includes a flat panel display and a sensor. The sensor detects a contacting point between a stylus or a finger and the flat panel display. The sensor may be a capacitance touch-panel, an electromagnetic induction digitizer, or the like. The flat panel display may be a liquid crystal display (LCD).

Connector 14 is arranged at a lower end (lower surface) of the body 11 for a mechanical and electrical joint of the body 11 and the base 22.

If the PC 10 is used in the tablet style as in FIG. 1, the touch-screen display 17 is mainly used as an input device.

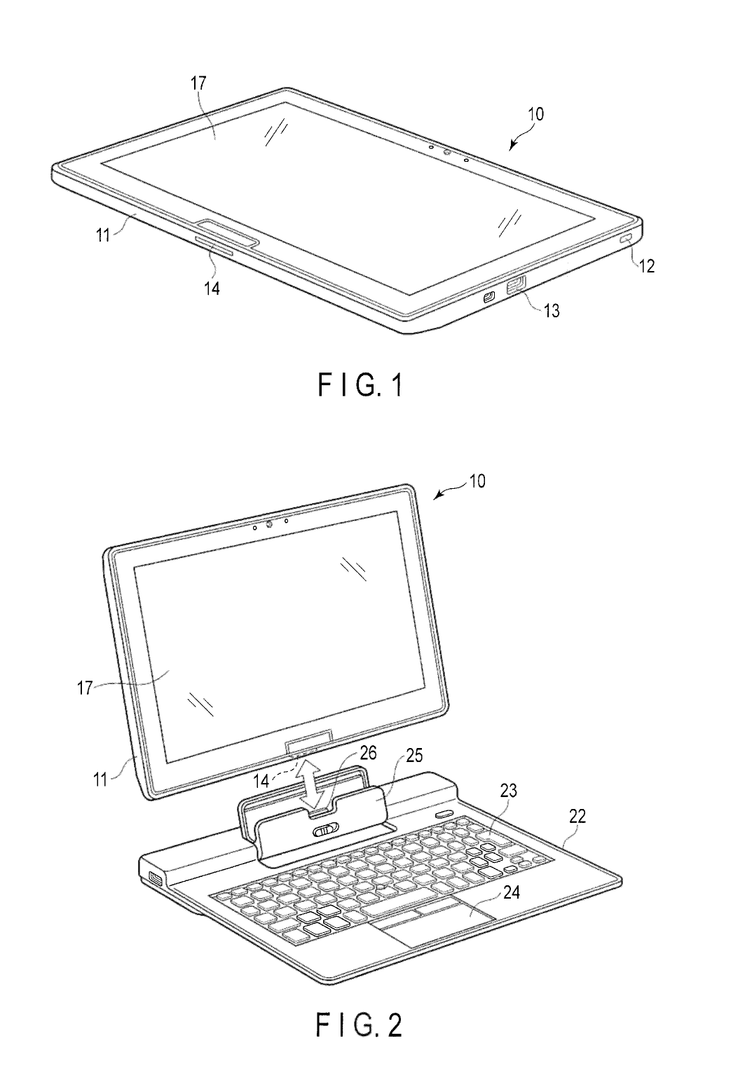

FIG. 2 shows a relationship between the body 11 and the base 22.

The base 22 has a thin box-like casing. Keyboard 23 and pointing device (touchpad) 24 are arranged on the upper surface of the casing. Furthermore, a rotatable hinge 25 supporting the body 11 is attached at the rear end of the upper surface of the casing. The body 11 is detachably attached to the rotatable hinge 25. The rotatable hinge 25 includes a connector 26 used for a mechanical and electrical joint of the body 11 and the base 22. When the lower end of the body 11 is inserted into the rotatable hinge 25, connector 14 of the body is connected to connector 26 in the rotatable hinge 25. Thereby, the body 11 is coupled with the base 22. Connectors 14 and 26 may be USB connectors or may be special docking ports (docking connectors).

FIG. 3 shows the exterior of the two-in-one PC 10 when it is in PC style (notebook configuration). When being attached to the base 22, the body 11 functions as a display monitor of the PC 10. While the PC 10 is in PC style as in FIG. 3, the keyboard 23 and touchpad 24 are mainly used as input devices. The user operates the keyboard 23 and the touchpad 24 to use the PC 10 as an ordinary notebook computer.

Note that the rotatable hinge 24 and connectors 14 and 26 are used as a mechanism to couple the body 11 and the base 22 together in the above example; however, no limitation is intended by this example. For example, a hinge fixed to the base 22 may be used for coupling instead of the rotatable hinge 25.

Or, instead of the base 22, if the above detachable keyboard is used as a device including a keyboard, the detachable keyboard on the body 11 may be magnetically bonded on the body. As a communication interface between the body 11 and the detachable keyboard, a wireless interface such as Bluetooth® may be used instead of a wired interface using connectors 14 and 26.

In this embodiment, the two-in-one PC 10 is used as a client device to communicate with a server which provides a virtual desktop environment. The virtual desktop environment (including operating system and application program) is executed by the server. The two-in-one PC 10 receives a virtual desktop image delivered by the server and displays the image on the touch-screen display 17. The two-in-one PC 10 transmits input data (user operation data) input via the input device to the server. The server transmits a virtual desktop image in which the input data is reflected, that is, an updated virtual desktop image obtained by processing the input data, to the two-in-one PC 10.

However, virtual desktop images delivered by the server to a client device are in most cases designed for an ordinary desktop or notebook computer including keyboard and mouse. Thus, if the two-in-one PC 10 is used in PC style (notebook configuration), there is no problem whereas if it is used in tablet style (tablet configuration), the operability may be lowered. This is because the touch-screen display 17 is used as a main input device in tablet style (tablet configuration).

Considering this point, the two-in-one PC 10 of the present embodiment adopts a function to detect the style (configuration) of the PC 10 currently being used in order to request a virtual desktop image suitable for the style (configuration) currently being used to the server. In the server, there are two virtual desktop environments prepared beforehand; one capable of delivering virtual desktop images for PC style and the other capable of delivering virtual desktop images for tablet style. The server selects the virtual desktop environment suitable for the style (configuration) of the PC 10 currently being used from the two kinds of virtual desktop environments and executes the selected virtual desktop environment.

Note that the virtual desktop image here is a screen image used in a virtual desktop environment that is provided for the two-in-one PC 10 by the server, and includes various screen images displayed on the display of the two-in-one PC 10 such as operating system screen image (desktop screen image), application program screen image, and the like.

The virtual desktop image suitable for the tablet style may be designed specifically for a touch operation in which icons and menu buttons on the screen are directly manipulated with a finger or stylus. For example, the size of such icon or menu button in the virtual desktop image for tablet style may be designed larger than that in the virtual desktop image for the PC style.

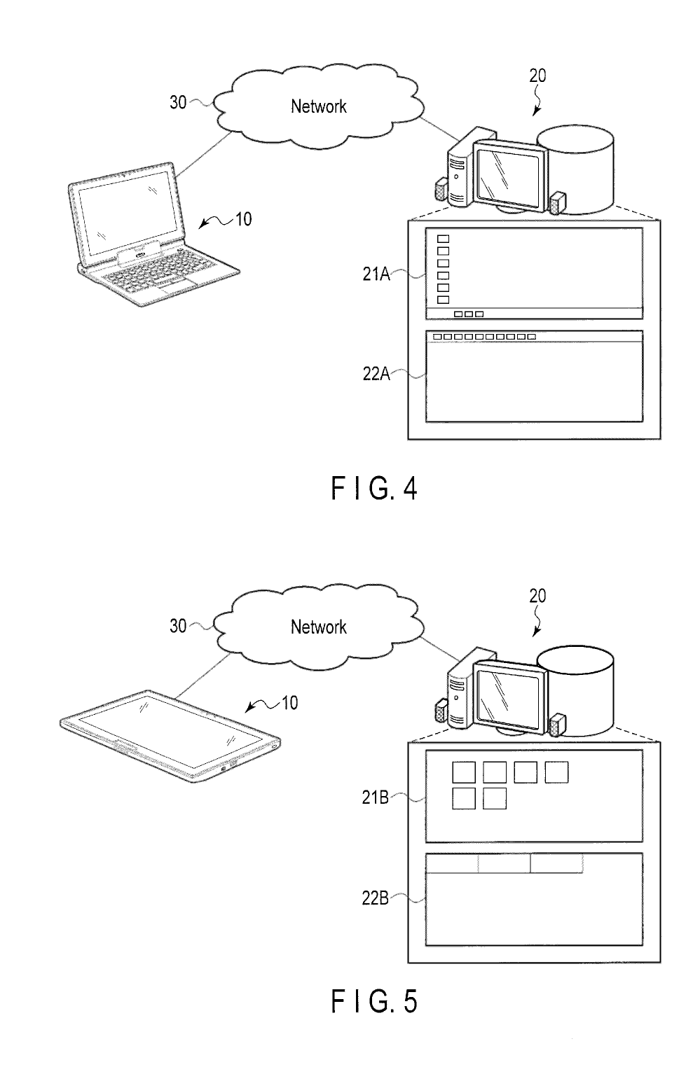

FIG. 4 shows examples of virtual desktop images provided by a server 20 for the two-in-one PC 10 in PC style.

The server 20 functions as a virtual desktop infrastructure (VDI) server which provides a virtual desktop environment for each of client devices including the two-in-one PC 10. The server 20 includes one or more physical servers. Each physical server includes one or more processors (CPUs).

The server 20 includes, as described above, two virtual desktop environments; one capable of delivering virtual desktop images for PC style and the other capable of delivering virtual desktop images for tablet style.

If in PC style, the two-in-one PC 10 transmits state data indicative of its PC style state to the server 20 over a network 30, in order to request the server 20 to execute the virtual desktop environment capable of delivering virtual desktop images for PC style.

Based on the state data, the processor in the server 20 selects the virtual desktop environment capable of delivering virtual desktop images for PC style from the two virtual desktop environments. The processor in the server 20 executes the selected virtual desktop environment using a virtual machine in the server. Through this process, the virtual desktop image for PC style is delivered from the server to the two-in-one PC 10 over the network 30.

In FIG. 4, reference numbers 21A and 22A denote examples of the virtual desktop images for PC style. For example, virtual desktop image 21A is a screen image (desktop screen image) delivered by the operating system in the selected virtual desktop environment and virtual desktop image 22A is a screen image delivered by an application program in the selected virtual desktop environment.

In both of the virtual desktop images 21A and 22A, the size of icons and menu buttons thereon are set to be suitably small for operation with input devices such as a keyboard and mouse.

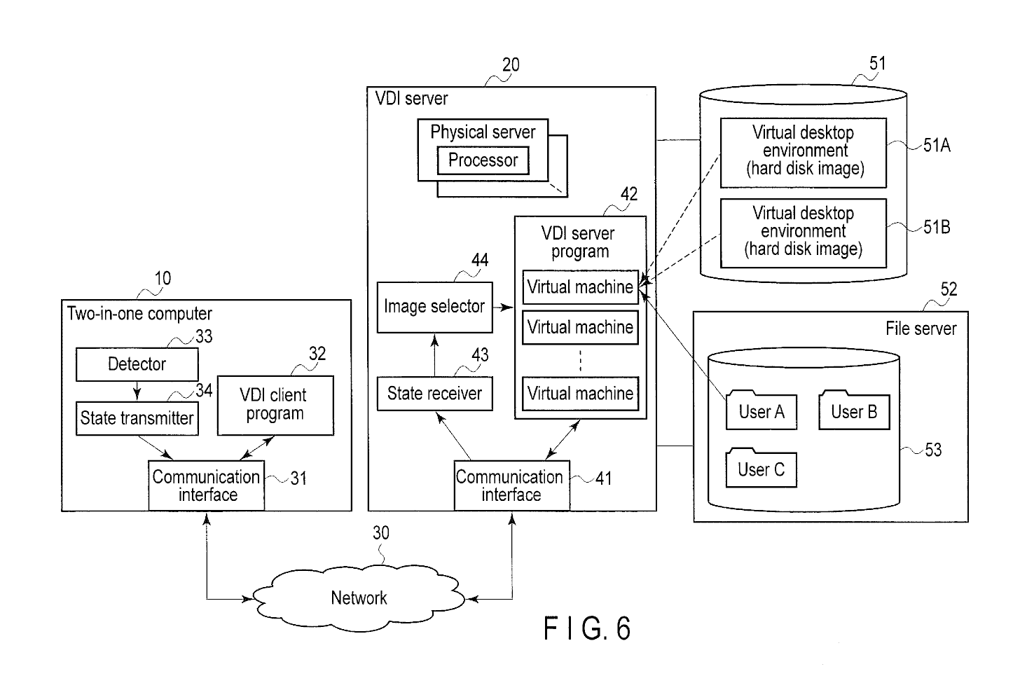

FIG. 5 shows examples of virtual desktop images provided by the server 20 for the two-in-one PC 10 in tablet style.

If being in tablet style, the two-in-one PC 10 transmits state data indicative of its tablet style state to the server 20 over the network 30, in order to request the server 20 to execute the virtual desktop environment capable of delivering virtual desktop images for tablet style.

Based on the state data, the processor in the server 20 selects the virtual desktop environment capable of delivering virtual desktop images for tablet style from the two virtual desktop environments. The processor in the server 20 executes the selected virtual desktop environment using a virtual machine in the server. Through this process, the virtual desktop image for tablet style is delivered from the server 20 to the two-in-one PC 10 over the network 30.

In FIG. 5, reference numbers 21B and 22B denote examples of the virtual desktop images for tablet style. For example, virtual desktop image 21B is a screen image (desktop screen image) delivered by the operating system in the selected virtual desktop environment and virtual desktop image 22B is a screen image delivered by an application program in the selected virtual desktop environment. In both of the virtual desktop images 21B and 22B, the size of icons and menu buttons thereon are set to be suitably large for a touch operation.

At the time when the two-in-one PC 10 logs in to the server 20, the state data indicative of the current style (current configuration) of the two-in-one PC 10 (PC style or tablet style) may be automatically transmitted to the server 20 together with login credential data (such as user ID and password input by the user on a login screen). In that case, the virtual desktop image suitable for the current style of the two-in-one PC 10 can be displayed on the screen of the two-in-one PC 10 immediately after the login of the two-in-one PC 10 to the server 20.

The style (configuration) of the two-in-one PC 10 may be changed from one to the other between the PC and tablet styles after the login of the two-in-one PC 10 to the server 20, that is, while the two-in-one PC 10 is in operation using the VDI.

In that case, the two-in-one PC 10 may transmit state change data indicative that its style (configuration) has been changed from one to the other between the PC and tablet styles to the server 20 over the network 30 in order to request the server 20 to switch the virtual desktop environment to be executed. Based on the state change data, the processor in the server 20 can switch the virtual desktop environment to the one suitable for the changed style.

As can be understood from the above, a suitable one is selectively executed from the two virtual desktop environments based on the style (configuration) of the two-in-one PC 10 in this embodiment. That is, a virtual desktop environment optimized for a tablet device can be used to deliver virtual desktop images corresponding to tablet style.

Thus, as compared to a case where only one virtual desktop environment operable in both the PC and tablet styles is constantly used, the operability in tablet style can be improved.

FIG. 6 shows a system structure including the two-in-one PC 10 and server (VDI server) 20.

The two-in-one PC 10 includes a communication interface 31, detector 33, and state transmitter 34. The two-in-one PC 10 executes a VDI client program 32.

The VDI client program 32 communicates with the VDI server 20 to receive virtual desktop images therefrom. The virtual desktop images are displayed on the screen of the two-in-one PC 10. The VDI client program 32 executes transmission of input data from an input device to the VDI server 20.

The communication interface 31 connects the two-in-one PC 10 to the VDI server 20 over the network 30. The communication interface 31 is composed of, for example, a communication device, device driver for the communication device, and middleware (protocol stack) for network communication control.

The detector 33 functions as a state detector to detect the style (configuration) of the two-in-one PC 10 currently being adopted from the two style (configurations); PC style in which the body 11 is attached to the base 22 and tablet style in which the body 11 is separated from the base 22. For example, the detector 33 may sense whether or not the body 11 and the base 22 are connected. If the base 22 and the body 11 are connected, the two-in-one PC 10 is determined to be in PC style. If the base 22 and the body 11 are not connected, the two-in-one PC 10 is determined to be in tablet style.

The detector 33 may be realized by a processor (CPU) in the two-in-one PC 10. The detector 33 may include a detecting circuit to detect the style (configuration) of the two-in-one PC 10 currently being adopted (that is, to determine whether or not the body 11 is attached to the base 22). For example, such a detecting circuit may observe voltage applied to a specific pin in a pin group of connector 14, and based on changes in the voltage applied to the specific pin, detect a connection between the body 11 and the base 22 or a release of the body 11 from the base 22. A bit indicative of voltage applied to the pin (that is, a bit indicative of PC style/tablet style) may be set in a specific register within the two-in-one PC 10. In that case, a microcomputer or a CPU in the two-in-one PC 10 may perform polling of the register at certain time intervals in order to determine which style the two-in-one PC 10 is in, PC style or tablet style. Or, such a microcomputer or a CPU may monitor an event notification (or interruption) indicative of a change in connection/release (disconnection) state in order to determine which style the two-in-one PC 10 is in, PC style or tablet style.

The state transmitter 34 transmits the state data indicative of the detected style of the two-in-one PC 10 to the VDI server 20 over the network 30 in conjunction with the communication interface 31. The state data includes a value indicative of a first state (PC style) in which the body 11 and the base 22 are connected or a value indicative of a second state (tablet style) in which the body 11 and the base 22 are not connected. The state transmitter 34 may be realized as an application program to transmit the state data indicative of the detected style of the two-in-one PC 10 to the VDI server 20. If the two-in-one PC 10 is in PC style, the state transmitter 34 transmits the state data of a value indicative of PC style to the VDI server 20. If the two-in-one PC 10 is in tablet style, the state transmitter 34 transmits the state data of a different value indicative of tablet style to the VDI server 20.

As explained above, the state data may be transmitted to the VDI server 20 together with the credential data used for login to the VDI server 20. In that case, the state transmitter 34 may acquire user ID and password input by a user on a login screen used for login to the VDI server 20 as the credential data. Then, the state transmitter 34 may execute a process to transmit the state data together with the acquired credential data to the VDI server 20.

The VDI server 20 and file server 52 function as a server system to provide a virtual desktop environment for each client device.

The VDI server 20 includes a communication interface 41, state receiver 43, and image selector 44. Furthermore, the VDI server 20 executes a VDI server program 42.

The VDI server program 42 is software used to provide a virtual desktop environment for each of the VDI client devices including the two-in-one PC 10. Multiple virtual machines are executed on the VDI server 20. The virtual machines individually execute the virtual desktop environments to be provided for the VDI clients. The virtual machines are individually executed on a virtualization layer which emulates the hardware resource of the VDI server 20. Note that the virtual machines may be executed on a different physical server than the VDI server 20.

The communication interface 41 connects the VDI server 20 to each of the VDI client devices over the network 30. The communication interface 41 is composed of, for example, a communication device, device driver for the communication device, and middleware (protocol stack) for network communication control.

The state receiver 43 receives state data or state change data from the two-in-one PC 10 in conjunction with the communication interface 41. The state receiver 43 may be realized as an application program to receive the state data or the state change data. In that case, such an application program may be executed on a management operating system of the VDI server 20.

Based on the state data (or the state change data) received by the state receiver 43, the image selector 44 selects one of two virtual desktop environments 51A and 51B in storage 51. The image selector 44 executes service for selecting a virtual desktop image suitable for the current style (current configuration) of the two-in-one PC 10 in conjunction with the VDI server program 42. The image selector 44 may be realized as service software operable in conjunction with the VDI server program 42.

Virtual desktop environment 51A is a virtual desktop environment capable of delivering a virtual desktop image for PC style. Virtual desktop environment 51A includes a hard disk image corresponding to an OS providing a desktop screen image suitable for keyboard and mouse operation. Furthermore, virtual desktop environment 51A includes a hard disk image corresponding to at least one application program which can run on the OS in virtual desktop environment 51A. The application program is used for execution of a specific function. The application program may be, for example, mailer, browser, word processing program, or presentation program. The application program provides a screen image suitable for the keyboard and mouse operation.

Virtual desktop environment 51B is a virtual desktop environment capable of delivering a virtual desktop image for tablet style. Virtual desktop environment 51B includes a hard disk image corresponding to an OS providing a desktop screen image suitable for touch operation. Furthermore, virtual desktop environment 51B includes a hard disk image corresponding to at least one application program which can run on the OS in virtual desktop environment 51B. The application program is used for execution of the same function as the application program in virtual desktop environment 51A. The application program provides a screen image suitable for the touch operation performed on the touch-screen display 17.

The OS of virtual desktop environment 51B and the OS of virtual desktop environment 51A may be of the same kind. In that case, various setting items related to the user interface of the OS of virtual desktop environment 51B are preset to provide a suitable working environment for a tablet device. For example, the size of icon and menu button may be enlarged for easy touch operation, and a software keyboard may take effect. Of course, the OS of virtual desktop environment 51B and the OS of virtual desktop environment 51A may be of different kinds.

The application program of virtual desktop environment 51B and the application program of virtual desktop environment 51A may be of the same kind. In that case, various setting items related to the user interface of the application program are preset to provide a suitable working environment for a tablet device.

The file server 52 manages a user data storage area configured to store user data of each user. The user data storage area is a part of storage area in storage 53. For example, if users A, B and C are initially registered in the VDI server 20, user data storage areas corresponding to users A, B and C, respectively, are created in storage 53.

The VDI server program 52 assigns one virtual machine to the two-in-one PC 10 (the user of the PC 10) which has logged into the VDI server 20. Then, the VDI server program 52 loads a virtual desktop environment (hard disk image) selected by the image selector 44 into the virtual machine. Through this process, the selected virtual desktop environment is executed using the virtual machine. The user data storage area corresponding to the user of the two-in-one PC 10 is mounted on the virtual machine. The user data storage area corresponding to the user of the two-in-one PC 10 is associated with the credential data (user ID) from the two-in-one PC 10.

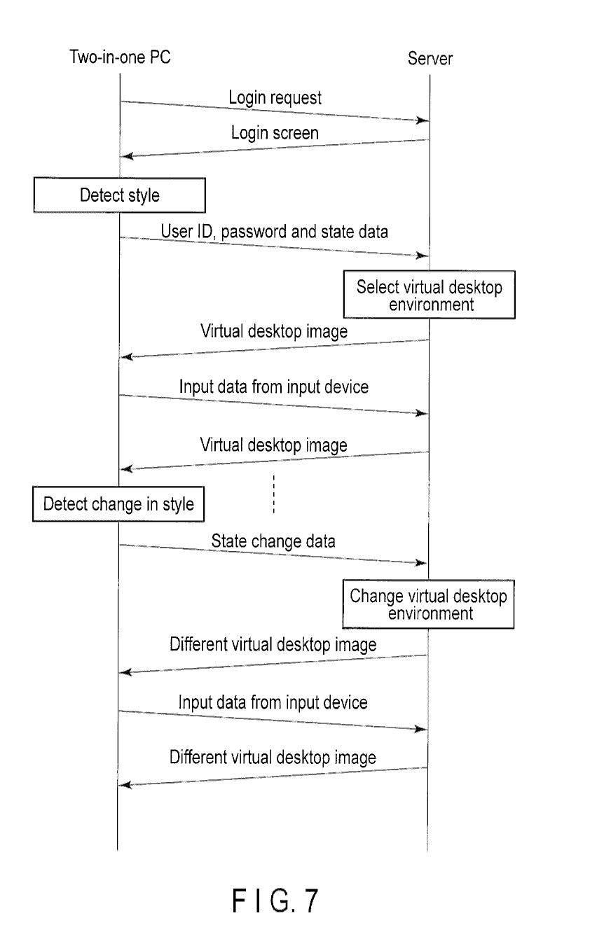

Now, with reference to FIG. 7, a communication procedure executed between the two-in-one PC 10 and the VDI server 20 is explained.

When the two-in-one PC 10 is turned on, the VDI client program 32 of the two-in-one PC 10 transmits a login request to the VDI server 20 and receives a login screen from the VDI server 20. The detector 33 detects a current style (current configuration) of the two-in-one PC 10. The state transmitter 34 transmits state data indicative of the detected style to the VDI server 20 together with credential data (user ID and password) input by the user on the login screen, in order to request the VDI server 20 to execute the virtual desktop environment suitable for the detected style.

Based on the state data from the two-in-one PC 10, the VDI server 20 executes a process to select the virtual desktop environment (one of virtual desktop environments 51A and 51B) suitable for the current style of the two-in-one PC 10. Then, the VDI server 20 executes a process to execute the selected virtual desktop environment using the virtual machine assigned to the two-in-one PC 10. The VDI server 20 transmits the virtual desktop image to the two-in-one PC 10, and receives input data from the two-in-one PC 10. The input data are processed to obtain an updated virtual desktop image, and the VDI server 20 transmits the updated virtual desktop image to the two-in-one PC 10.

If the detector 33 detects a change in style (configuration) of the two-in-one PC 10, the state transmitter 34 transmits state change data indicative of the change in style of the two-in-one PC 10 to the VDI server 20 and requests the VDI server 20 to switch the virtual desktop environment. The state change data may be indicative of a changed style (new style after change) alone. Based on the state change data, the VDI server 20 executes a process to switch the virtual desktop environment to be executed from one to the other between virtual desktop environments 51A and 51B. Then, the VDI server 20 transmits a different virtual desktop image obtained by the switch to virtual desktop environment 51A or 51B to the two-in-one PC 10 and receives the input data from the two-in-one PC 10. The input data are processed to obtain the updated virtual desktop image, and the VDI server 20 transmits the updated virtual desktop image to the two-in-one PC 10.

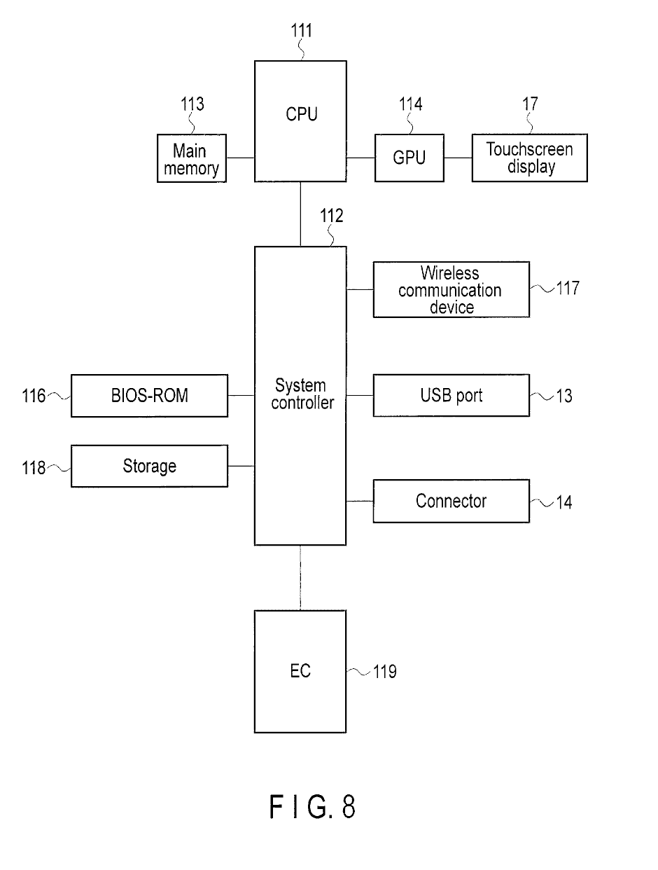

FIG. 8 shows a hardware structure of the two-in-one PC 10.

The two-in-one PC 10 includes, for example, a CPU 111, system controller 112, main memory 113, graphics processing unit (GPU) 114, BIOS-ROM 116, wireless communication device 117, storage 118, and embedded controller (EC) 119.

CPU 11 is a processor configured to execute various programs loaded from storage 118 into the main memory 113. For example, the VDI client program 32, and the application program to transmit state data (state change data) to the VDI server 20 are included in the various programs. Furthermore, the program to detect the style of the two-in-one PC 10 may be included in the various programs.

The system controller 112 is a bridge device connected between the CPU 11 and each component. The GPU 114 controls the touch-screen display 17 used as a display monitor of the two-in-one PC 10. The GPU 114 may be incorporated in the CPU 111.

The wireless communication device 117 functions as the above-described communication interface 31. The wireless communication device 117 is a wireless LAN controller which performs wireless communication conforming to IEEE 802.11 standard. The embedded controller (EC) 119 performs power management to power on/off of the two-in-one PC 10.

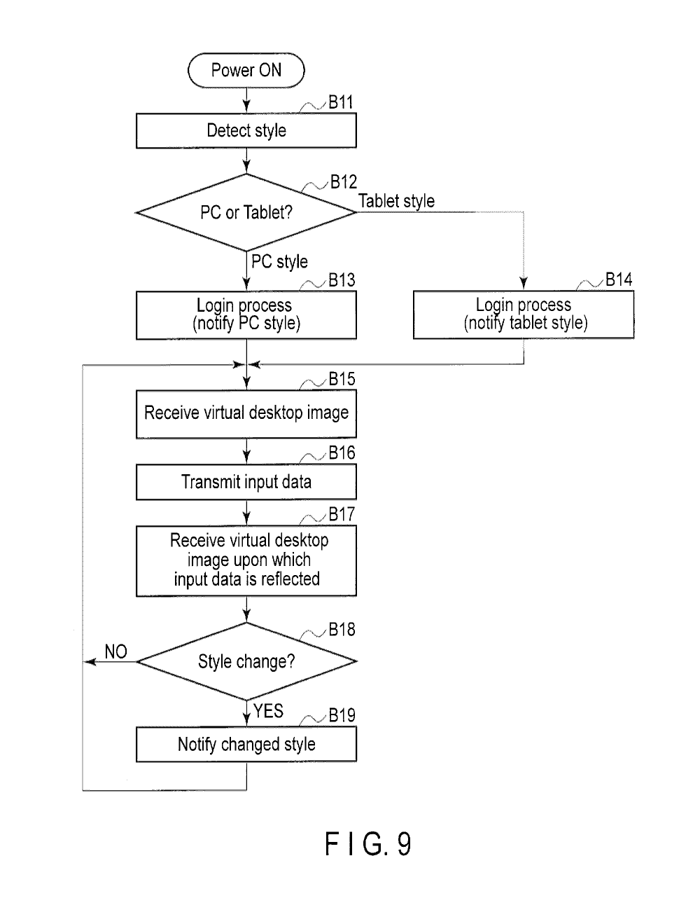

FIG. 9 shows a flowchart of the process executed by the two-in-one PC 10.

When the two-in-one PC 10 is turned on, the detector 33 determines whether or not the body 11 and the base 22 are connected (linked) together to detect the current style of the two-in-one PC 10, PC style or tablet style (block B11). If a connection between the body 11 and the base 22 is detected, the detector 33 may store, in the above-mentioned register or the other memory, a value (bit) indicative that the two-in-one PC 10 is in the PC style (PC mode). On the other hand, if a connection between the body 11 and the base 22 is not detected, that is, if a detachment of the body 11 from the base 22 is detected, the detector 33 may store, in the above-mentioned register or the other memory, a value (bit) indicative that the two-in-one PC 10 is in the tablet style (tablet mode).

The CPU 111 executes the VDI client program 32 and the application program corresponding to the state transmitter 34. Under the control of the VDI client program 32, the CPU 111 transmits a login request to the VDI server 20 over the network 30, and receives a login screen from the VDI server 20 over the network 30.

Under the control of the application program corresponding to the state transmitter 34, the CPU 111 determines which style the two-in-one PC 10 is in, PC style or tablet style, based on a detection result from the detector 33 (for example, the value stored in the register or in the memory) (block B12).

If the current style of the two-in-one PC 10 is in PC style, the CPU 111 transmits state data indicative of PC style to the VDI server 20 over the network 30 together with credential data used for login to the VDI server 20, in order to request the VDI server 20 to execute a virtual desktop environment for PC style (block B13).

On the other hand, if the current configuration of the two-in-one PC 10 is in tablet style, the CPU 111 transmits state data indicative of tablet style to the VDI server 20 over the network 30 together with credential data used for login to the VDI server 20, in order to request the VDI server 20 to execute a virtual desktop environment for tablet style (block B14).

Under the control of the VDI client program 32, the CPU 111 communicates with the VDI server 20 and receives a virtual desktop image from the VDI server 20 over the network 30 (block B15). The virtual desktop image is displayed on the screen of the two-in-one PC 10. Under the control of the VDI client program 32, the CPU 111 transmits input data from an input device to the VDI server 20 over the network 30 (block B16). Furthermore, the CPU 111 receives the virtual desktop image upon which the input data are reflected from the VDI server 20 over the network 30 (block B17).

Under the control of the application program corresponding to the state transmitter 34, the CPU 111 determines whether or not the detector 33 has detected a change in style of the two-in-one PC 10 after the login of the two-in-one PC 10 (block B18). If the CPU 111 determines that a change in style of the two-in-one PC 10 has been detected (YES in block B18), the CPU 111 then transmits state change data indicative of a change in style of the two-in-one PC 10 from one to the other between the notebook and tablet styles to the VDI server 20 over the network 30 in order to request the switch of the virtual desktop environment to be executed (block B19).

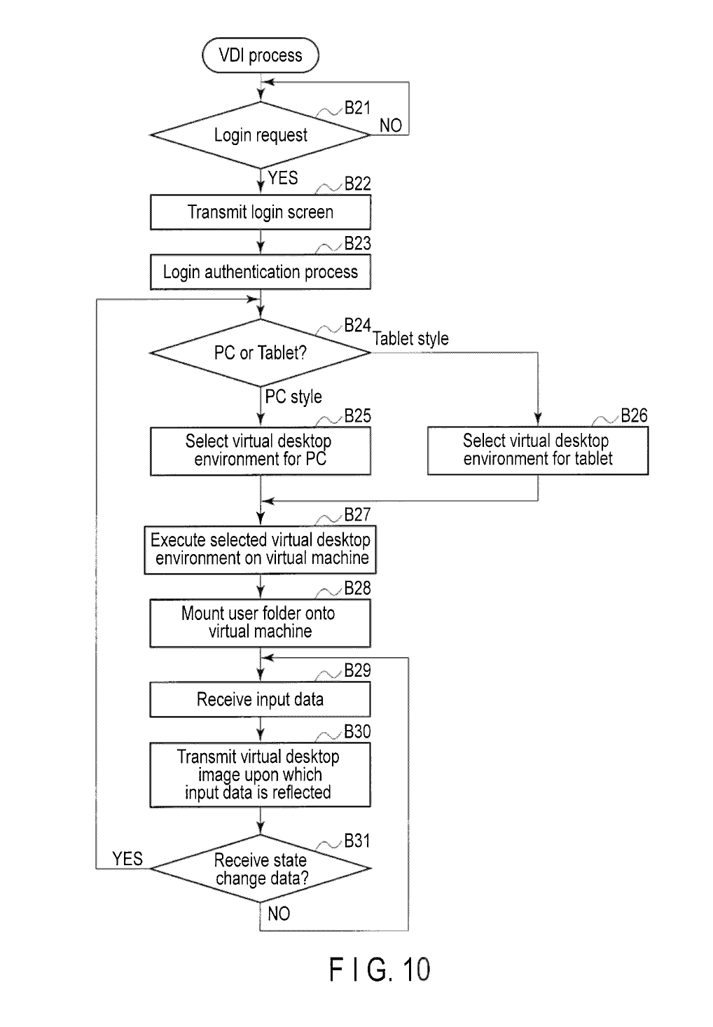

FIG. 10 is a flowchart which shows a VDI process procedure executed by the VDI server 20.

If the VDI server 20 receives a login request from the two-in-one PC 10 (YES in block B21), the processor in the VDI server 20 transmits a login screen to the two-in-one PC 10 over the network 30 (block B22). The processor in the VDI server 20 executes a login authentication process to identify a user account to log into the VDI server 20 based on the credential data input via the login screen (block B23). In block B23, the processor in the VDI server 20 determines whether or not the credential data received from the two-in-one PC 10 matches to one of a plurality of credential data registered in the VDI server 20. If the credential data received from the two-in-one PC 10 matches to any of the credential data registered in the VDI server 20, login of the two-in-one PC 10 to the VDI server 20 is granted.

After the login of the two-in-one PC 10 to the VDI server 20 has been granted, the processor in the VDI server 20 prepares a virtual machine to be assigned to the two-in-one PC 10. In this preparation process, the processor in the VDI server 20 determines which style (state) is indicated by the state data sent together with the credential data from the two-in-one PC 10, PC style (connected state) or tablet style (unconnected state) (block B24).

If the style indicated by the state data is PC style, the processor in the VDI server 20 selects a virtual desktop environment 51A for a PC (block B25). Then, the processor in the VDI server 20 performs a process to execute the selected virtual desktop environment 51A using the virtual machine assigned to the two-in-one PC 10 (first virtual machine) (block B27). In block B27, the selected virtual desktop environment 51A is loaded into the virtual machine (first virtual machine). Furthermore, the processor in the VDI server 20 performs a process to mount the user data storage area corresponding to the user of the two-in-one PC 10, that is, the user data storage area (user folder) associated to the credential data from the two-in-one PC 10 onto the virtual machine (first virtual machine) (block B28).

On the other hand, if the style indicated by the state data is tablet style, the processor in the VDI server 20 selects a virtual desktop environment 51B for a tablet device (block B26). Then, the processor in the VDI server 20 performs a process to execute the selected virtual desktop environment 51B using the virtual machine assigned to the two-in-one PC 10 (first virtual machine) (block B27). In block B27, the selected virtual desktop environment 51B is loaded into the virtual machine (first virtual machine). Furthermore, the processor in the VDI server 20 performs a process to mount the user data storage area corresponding to the user of the two-in-one PC 10, that is, the user data storage area (user folder) associated to the credential data from the two-in-one PC 10 onto the virtual machine (first virtual machine) (block B28).

Then, the virtual machine (first virtual machine) executes the virtual desktop environment 51A or 51B and transmits the virtual desktop image to the two-in-one PC 10. When the virtual machine receives the input data from the two-in-one PC 10 (block B29), the virtual machine (first virtual machine) executes a process corresponding to the input data and transmits the virtual desktop image upon which input data has been reflected to the two-in-one PC 10 (block B30).

The processor in the VDI server 20 determines whether or not the state change data indicative of a change in style of the two-in-one PC 10 have been received from the two-in-one PC 10 (block B31). If the state change data have been received from the two-in-one PC 10 (YES in block B31), the processor in the VDI server 20 executes a process to switch the virtual desktop environment from the one currently being executed to the other virtual desktop environment (a virtual desktop environment corresponding to a new style indicated by the state change data) (blocks B24 to B28). In blocks B24 to B28, the processor in the VDI server 20 executes both a process execute the other virtual desktop environment using a different virtual machine (second virtual machine) than the first virtual machine and a process to switch the first virtual machine to the second virtual machine on which the user data storage area corresponding to the user of the two-in-one PC 10 is mounted. Through this process, the virtual desktop environment provided for the two-in-one PC 10 can be switched without logging in again to the VDI server 20.

For example, a case where the style of the two-in-one PC 10 is changed from PC style to tablet style after login to the VDI server 20 is now considered. The processor in the VDI server 20 receives state change data indicative of a style change into tablet style from the two-in-one PC 10. The processor in the VDI server 20 may automatically execute a process to save the data of the application program currently being executed by the first virtual machine in the user data storage area corresponding to the user of the two-in-one PC 10. Alternatively, at the time of a style change in the two-in-one PC 10, the CPU 111 in the two-in-one PC 10 may display a message to prompt a user to save data on the screen of the two-in-one PC 10. In that case, the input data corresponding to a data saving operation by the user are transmitted from the two-in-one PC 10 to the VDI server 20. The first virtual machine in the VDI server 20 executes a process to save the data based on the input data.

Then, the processor in the VDI server 20 selects the virtual desktop environment 51B for a tablet device (block B29). The processor in the VDI server 20 executes a process to execute the virtual desktop environment 51B using a different virtual machine (second virtual machine) in the VDI server 20 (block B30). The processor in the VDI server 20 unmounts from the first virtual machine the user data storage area corresponding to the user of the two-in-one PC 10 and mounts the user data storage area onto the second virtual machine (block B31). That is, the user data storage area is unmounted from the file system of the OS of the first virtual machine and then mounted into the file system of the OS of the second virtual machine. Through this process, the virtual desktop environment that is provided for the two-in-one PC 10 by the VDI server 20 can be switched without logging in again to the VDI server 20.

Note that the process shown in the flowchart of FIG. 10 can be executed by one or more processors in the VDI server 20.

As explained above, in the present embodiment, the state data indicative of the style (configuration) of the two-in-one PC 10 is transmitted from the two-in-one PC 10 to the VDI server 20. Then, based on the state data, a virtual desktop environment for a PC or a virtual desktop environment for a tablet device is executed selectively. Thus, when the two-in-one PC 10 is used in PC style (PC configuration), the virtual desktop environment for PC use, such as ordinary virtual desktop environment, can be provided, and on the other hand, when the two-in-one PC 10 is used in tablet style (tablet configuration), the virtual desktop environment optimized for a tablet use can be provided. Since the virtual desktop image suitable for the current style of the two-in-one PC 10 can be displayed on the screen of the two-in-one PC 10, sufficient operability can be achieved in either of PC style or tablet style.

Note that each of various functions described in the embodiments may be implemented by a processing circuitry. As a processing circuitry, a programmed processor such as central processing unit (CPU) can be used. The processor performs the described functions individually by executing programs stored in the memory. The processor may be a microprocessor including electrical circuits. The processing circuitry may be, for example, a digital signal processor (DSP), application specific integrated circuit (ASIC), microcontroller, controller, and other electrical circuit components.

Processes in the procedure shown in the flowchart of FIG. 9 are achievable individually by a computer program. Thus, the advantage obtained by the present embodiment can easily be achieved by installing and executing such a computer program which executes each process in the procedure in an ordinary two-in-one PC 10 through a computer-readable storage medium which stores the computer program.

Similarly, processes in the procedure shown in the flowchart of FIG. 10 are achievable individually by a computer program. Thus, the advantage obtained by the present embodiment can easily be achieved by installing and executing such a computer program which executes each process in the procedure in a server through a computer-readable storage medium which stores the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising an information processing apparatus and a server,
the information processing apparatus comprising:
a body comprising a touch-screen display; and
a first processor configured to:
execute a process to detect a current configuration of the information processing apparatus from a first configuration in which the body is attached to a device comprising a keyboard and a second configuration in which the body is separated from the device; and
execute a process to transmit state data indicative of the detected configuration to the server, and
the server comprising a second processor configured to select a virtual desktop environment, based on the state data, from a first virtual desktop environment capable of delivering a first virtual desktop image for the first configuration and a second virtual desktop environment capable of delivering a second virtual desktop image for the second configuration, and execute the virtual desktop environment using a first virtual machine.

2. The system of claim 1, wherein the state data are transmitted from the information processing apparatus to the server together with credential data used for login to the server.

3. The system of claim 2, wherein the second processor is further configured to switch, when the server receives the state data indicative of a change in configuration after the information processing apparatus logs into the server, the first virtual desktop environment and the second virtual desktop environment.

4. The system of claim 3, wherein the second processor is further configured to execute a switched virtual desktop environment using a second virtual machine different from the first virtual machine, and switch from the first virtual machine to the second virtual machine where a first user data storage area associated with the credential data is to be mounted.

5. The system of claim 1,
wherein the first virtual desktop environment comprises a first operating system capable of delivering a screen image for the first configuration and a first application program to execute a first function, the first application program capable of delivering a screen image for the first configuration, and
wherein the second virtual desktop environment comprises a second operating system capable of delivering a screen image for the second configuration and a second application program to execute the first function, the second application program capable of delivering a screen image for the second configuration.

6. A virtual desktop environment selection method, the method executed by a server that provides a virtual desktop environment for an information processing apparatus comprising a body comprising a touch-screen display, the method comprising:
receiving state data from the information processing apparatus, the state data indicative of a current configuration of the information processing apparatus comprising a first configuration in which the body is attached to a device comprising a keyboard and a second configuration in which the body is separated from the device;
selecting, based on the state data, the virtual desktop environment from a first virtual desktop environment capable of delivering a first virtual desktop image for the first configuration and a second virtual desktop environment capable of delivering a second virtual desktop image for the second configuration; and
executing the virtual desktop environment using a first virtual machine.

7. The virtual desktop environment selection method of claim 6, wherein the state data are transmitted from the information processing apparatus to the server together with credential data used for login to the server.

8. The virtual desktop environment selection method of claim 7, further comprising switching, when the server receives the state data indicative of a change in configuration after the information processing apparatus logs into the server, the first virtual desktop environment and the second virtual desktop environment.

9. The virtual desktop environment selection method of claim 8, further comprising executing a switched virtual desktop environment using a second virtual machine different from the first virtual machine, and switching from the first virtual machine to the second virtual machine where a first user data storage area associated with the credential data is mounted.

10. The virtual desktop environment selection method of claim 6,
wherein the first virtual desktop environment comprises a first operating system capable of delivering a screen image for the first configuration and a first application program to execute a first function, the first application program capable of delivering a screen image for the first configuration, and
wherein the second virtual desktop environment comprises a second operating system capable of delivering a screen image for the second configuration and a second application program to execute the first function, the second application program capable of delivering a screen image for the second configuration.

11. An information processing apparatus, comprising:
a body comprising a touch-screen display; and
a processor configured to:
execute a process to detect a current configuration of the information processing apparatus from a first configuration in which the body is attached to a device comprising keyboard and a second configuration in which the body is separated from the device;
execute, when the information processing apparatus is in the first configuration, a process to transmit first data indicative of the first configuration to a server in order to request the server to execute a first virtual desktop environment capable of delivering the first virtual desktop image for the first configuration; and
execute, when the information processing apparatus is in the second configuration, a process to transmit second data indicative of the second configuration to the server in order to request the server to execute a second virtual desktop environment capable of delivering the second virtual desktop image for the second configuration.

12. The information processing apparatus of claim 11, wherein the processor is further configured to transmit, after the information processing apparatus is tuned on, one of the first data and the second data to the server together with credential data used for login to the server.

13. The information processing apparatus of claim 12, wherein the processor is further configured to execute, when a change in configuration is detected after login, a process to transmit third data indicative of the change in configuration to the server in order to request the server to switch the first virtual desktop environment and the second virtual desktop environment to be executed.

14. The information processing apparatus of claim 11,
wherein the first virtual desktop environment comprises a first operating system capable of delivering a screen image for the first configuration and a first application program to execute a first function, the first application program capable of delivering a screen image for the first configuration, and
wherein the second virtual desktop environment comprises a second operating system capable of delivering a screen image for the second configuration and a second application program to execute the first function, the second application program capable of delivering a screen image for the second configuration.
